(19) United States
(12) Patent Application Publication
(10) Pub. No.: US 2026/0052572 A1
(43) Pub. Date: Feb. 19, 2026

(54) UPLINK TRANSMISSION SWITCHING FOR UNLICENSED BANDS

(71) Applicant: QUALCOMM Incorporated, San Diego, CA (US)

(72) Inventors: Yiqing CAO, Beijing (CN); Peter GAAL, San Diego, CA (US); Juan MONTOJO, San Diego, CA (US)

(21) Appl. No.: 19/101,845

(22) PCT Filed: Nov. 3, 2022
(86) PCT No.: PCT/CN2022/129429

§ 371 Date: Feb. 6, 2025

(51) Int. Cl. H04W 74/0816; H04W 72/1268

(52) U.S. Cl. CPC H04W 74/0816; H04W 72/1268

(57) ABSTRACT

Methods, systems, and devices for wireless communications are described. A user equipment (UE) may receive a control message indicating a set of scheduling parameters for transmission of an uplink message via a licensed radio frequency (RF) spectrum band. The UE may perform one or more listening procedures for a shared RF spectrum band to determine whether shared resources are available for the uplink message. If the one or more listening procedures are successful, the UE may perform uplink transmit switching to transmit the uplink message via available shared resources of the shared RF spectrum band in accordance with a portion of the set of scheduling parameters. If the one or more listening procedures are unsuccessful, the UE may transmit the uplink message via the licensed RF spectrum band. A network entity may monitor both the licensed RF spectrum band and the shared RF spectrum band to receive the uplink message.

### CROSS REFERENCE

This application is a 371 National Stage of PCT Application No. PCT/CN2022/129429, filed on Nov. 3, 2022, entitled “UPLINK TRANSMISSION SWITCHING FOR UNLICENSED BANDS”, and assigned to the assignee hereof. The disclosure of the prior Application is considered part of and is incorporated by reference into this Patent Application.

### FIELD OF TECHNOLOGY

The following relates to wireless communications, including uplink transmission switching for unlicensed bands.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples, a UE may be configured to support two concurrent uplink transmissions using a first transmit chain and a second transmit chain. The transmit chains may be configured, at any given time, to transmit on different frequency bands or component carriers. The UE may switch between transmit chain configurations during an uplink switching period.

### SUMMARY

The described techniques relate to improved methods, systems, devices, and apparatuses that support uplink transmission switching for unlicensed bands. For example, the described techniques enable a user equipment (UE) to receive a control message indicating a set of scheduling parameters for transmission of an uplink message via a licensed radio frequency (RF) spectrum band. The UE may perform one or more listening procedures for a shared RF spectrum band to determine whether shared resources are available for the uplink message. If the one or more listening procedures are successful, the UE may perform uplink transmit switching from the licensed band to the unlicensed band and may transmit the uplink message via one or more available shared resources of the shared RF spectrum band in accordance with a portion of the set of scheduling parameters. If the one or more listening procedures are unsuccessful, the UE may transmit the uplink message via the licensed RF spectrum band. A network entity may monitor both the licensed RF spectrum band and the shared RF spectrum band to receive the uplink message. In some cases, the UE may report feedback to the network entity indicating whether the one or more listening procedures were successful.

A method for wireless communications at a UE is described. The method may include receiving a control message that indicates a set of scheduling parameters for transmission of an uplink message via a licensed RF spectrum band, performing, based on the set of scheduling parameters, one or more listening procedures for a shared RF spectrum band to detect whether shared resources are available for the uplink message, and transmitting the uplink message via one or more shared resources of the shared RF spectrum band in accordance with at least a portion of the set of scheduling parameters based on a result of the one or more listening procedures.

An apparatus for wireless communications at a UE is described. The apparatus may include a processor, memory coupled with the processor, and instructions stored in the memory. The instructions may be executable by the processor to cause the apparatus to receive a control message that indicates a set of scheduling parameters for transmission of an uplink message via a licensed RF spectrum band, perform, based on the set of scheduling parameters, one or more listening procedures for a shared RF spectrum band to detect whether shared resources are available for the uplink message, and transmit the uplink message via one or more shared resources of the shared RF spectrum band in accordance with at least a portion of the set of scheduling parameters based on a result of the one or more listening procedures.

Another apparatus for wireless communications at a UE is described. The apparatus may include means for receiving a control message that indicates a set of scheduling parameters for transmission of an uplink message via a licensed RF spectrum band, means for performing, based on the set of scheduling parameters, one or more listening procedures for a shared RF spectrum band to detect whether shared resources are available for the uplink message, and means for transmitting the uplink message via one or more shared resources of the shared RF spectrum band in accordance with at least a portion of the set of scheduling parameters based on a result of the one or more listening procedures.

A non-transitory computer-readable medium storing code for wireless communications at a UE is described. The code may include instructions executable by a processor to receive a control message that indicates a set of scheduling parameters for transmission of an uplink message via a licensed RF spectrum band, perform, based on the set of scheduling parameters, one or more listening procedures for a shared RF spectrum band to detect whether shared resources are available for the uplink message, and transmit the uplink message via one or more shared resources of the shared RF spectrum band in accordance with at least a portion of the set of scheduling parameters based on a result of the one or more listening procedures.

In some examples of the method, apparatuses, and non-transitory computer-readable medium described herein, transmitting the uplink message may include operations, features, means, or instructions for switching from the licensed RF spectrum band to the shared RF spectrum band based on the success result, where the uplink message may be transmitted via the one or more shared resources based on the switching.

Some examples of the method, apparatuses, and non-transitory computer-readable medium described herein may further include operations, features, means, or instructions for switching from the shared RF spectrum band to the licensed RF spectrum band after transmitting the uplink message.

In some examples of the method, apparatuses, and non-transitory computer-readable medium described herein, a preparation time between receiving the control message and transmitting the uplink message may be based on a switching period between bands for the UE, one or more capabilities of the UE, and a listening period corresponding to the one or more listening procedures.

In some examples of the method, apparatuses, and non-transitory computer-readable medium described herein, the listening period includes a time duration or a symbol duration.

In some examples of the method, apparatuses, and non-transitory computer-readable medium described herein, a start time of the switching period corresponds to the UE detecting that the one or more shared resources of the shared RF spectrum band may be available for the uplink message.

Some examples of the method, apparatuses, and non-transitory computer-readable medium described herein may further include operations, features, means, or instructions for transmitting a feedback report associated with the uplink message based on performing the one or more listening procedures.

In some examples of the method, apparatuses, and non-transitory computer-readable medium described herein, transmitting the feedback report may include operations, features, means, or instructions for transmitting an acknowledgement associated with transmitting the uplink message via the one or more shared resources of the shared RF spectrum band based on the result including a success result.

In some examples of the method, apparatuses, and non-transitory computer-readable medium described herein, transmitting the feedback report may include operations, features, means, or instructions for transmitting a negative acknowledgement based on the result including a failure result.

In some examples of the method, apparatuses, and non-transitory computer-readable medium described herein, up to two transmissions may be scheduled for the licensed RF spectrum band and the shared RF spectrum band.

A method for wireless communications at a network entity is described. The method may include transmitting, to a UE, a control message that indicates a set of scheduling parameters for transmission of an uplink message via a licensed RF spectrum band, monitoring the licensed RF spectrum band and a shared RF spectrum band different from the licensed RF spectrum band for the uplink message, and receiving, from the UE, the uplink message via one or more shared resources of the shared RF spectrum band in accordance with at least a portion of the set of scheduling parameters based on the monitoring.

An apparatus for wireless communications at a network entity is described. The apparatus may include a processor, memory coupled with the processor, and instructions stored in the memory. The instructions may be executable by the processor to cause the apparatus to transmit, to a UE, a control message that indicates a set of scheduling parameters for transmission of an uplink message via a licensed RF spectrum band, monitor the licensed RF spectrum band and a shared RF spectrum band different from the licensed RF spectrum band for the uplink message, and receive, from the UE, the uplink message via one or more shared resources of the shared RF spectrum band in accordance with at least a portion of the set of scheduling parameters based on the monitoring.

Another apparatus for wireless communications at a network entity is described. The apparatus may include means for transmitting, to a UE, a control message that indicates a set of scheduling parameters for transmission of an uplink message via a licensed RF spectrum band, means for monitoring the licensed RF spectrum band and a shared RF spectrum band different from the licensed RF spectrum band for the uplink message, and means for receiving, from the UE, the uplink message via one or more shared resources of the shared RF spectrum band in accordance with at least a portion of the set of scheduling parameters based on the monitoring.

A non-transitory computer-readable medium storing code for wireless communications at a network entity is described. The code may include instructions executable by a processor to transmit, to a UE, a control message that indicates a set of scheduling parameters for transmission of an uplink message via a licensed RF spectrum band, monitor the licensed RF spectrum band and a shared RF spectrum band different from the licensed RF spectrum band for the uplink message, and receive, from the UE, the uplink message via one or more shared resources of the shared RF spectrum band in accordance with at least a portion of the set of scheduling parameters based on the monitoring.

Some examples of the method, apparatuses, and non-transitory computer-readable medium described herein may further include operations, features, means, or instructions for determining that an uplink transmit switching procedure of the UE was successful based on receiving the uplink message via the one or more shared resources of the shared RF spectrum band.

In some examples of the method, apparatuses, and non-transitory computer-readable medium described herein, a preparation time between transmitting the control message and receiving the uplink message may be based on a switching period between bands for the UE, one or more capabilities of the UE, and a listening period for the UE.

In some examples of the method, apparatuses, and non-transitory computer-readable medium described herein, the listening period includes a time duration or a symbol duration.

Some examples of the method, apparatuses, and non-transitory computer-readable medium described herein may further include operations, features, means, or instructions for receiving a feedback report associated with the uplink message based on the monitoring.

In some examples of the method, apparatuses, and non-transitory computer-readable medium described herein, receiving the feedback report may include operations, features, means, or instructions for receiving an acknowledgement associated with receiving the uplink message via the one or more shared resources of the shared RF spectrum band.

In some examples of the method, apparatuses, and non-transitory computer-readable medium described herein, receiving the feedback report may include operations, features, means, or instructions for receiving a negative acknowledgement associated with receiving the uplink licensed message via the licensed RF spectrum band.

### BRIEF DESCRIPTION OF THE DRAWINGS

FIG. 1 illustrates an example of a wireless communications system that supports uplink transmission switching for unlicensed bands in accordance with one or more aspects of the present disclosure.

FIG. 2 illustrates an example of a wireless communications system that supports uplink transmission switching for unlicensed bands in accordance with one or more aspects of the present disclosure.

FIG. 3 illustrates an example of a switching timeline that supports uplink transmission switching for unlicensed bands in accordance with one or more aspects of the present disclosure.

FIG. 4 illustrates an example of a process flow that supports uplink transmission switching for unlicensed bands in accordance with one or more aspects of the present disclosure.

FIGS. 5 and 6 illustrate block diagrams of devices that support uplink transmission switching for unlicensed bands in accordance with one or more aspects of the present disclosure.

FIG. 7 illustrates a block diagram of a communications manager that supports uplink transmission switching for unlicensed bands in accordance with one or more aspects of the present disclosure.

FIG. 8 illustrates a diagram of a system including a device that supports uplink transmission switching for unlicensed bands in accordance with one or more aspects of the present disclosure.

FIGS. 9 and 10 illustrate block diagrams of devices that support uplink transmission switching for unlicensed bands in accordance with one or more aspects of the present disclosure.

FIG. 11 illustrates a block diagram of a communications manager that supports uplink transmission switching for unlicensed bands in accordance with one or more aspects of the present disclosure.

FIG. 12 illustrates a diagram of a system including a device that supports uplink transmission switching for unlicensed bands in accordance with one or more aspects of the present disclosure.

FIGS. 13 through 16 illustrate flowcharts showing methods that support uplink transmission switching for unlicensed bands in accordance with one or more aspects of the present disclosure.

### DETAILED DESCRIPTION

In some wireless communications systems, a user equipment (UE) may support two or more concurrent (e.g., simultaneous or at least partially overlapping in time) uplink messages on a same or different component carrier using two or more radio frequency (RF) chains, which may be referred to as transmit or receive chains. An RF chain (e.g., a transmit chain or receive chain) may refer to circuitry or components capable of generating and transmitting an uplink message by the UE (or in case of a receiving, an RF chain may be capable of receiving and decoding a message received by the UE). At a given time, each RF chain may be mapped to a single antenna port at the UE for transmission of an uplink signal. The RF chains may be configured to dynamically switch between antenna ports, between frequency bands, between component carriers, or any combination thereof. For example, a UE configured with two RF chains may be configured to transmit uplink messages on two frequency bands using a single RF chain on each component carrier, or the UE may be configured to transmit on one of the frequency bands using both of the RF chains and refrain from transmitting on the other frequency band at the same time.

The UE may perform uplink transmit switching between frequency bands by dynamically switching a configuration of a given RF chain during an uplink switching period. Uplink transmit switching may increase uplink signaling throughput and improve resource utilization. However, a UE may be unable to perform uplink switching between a licensed frequency band (e.g., a licensed RF spectrum band) and a shared frequency band (e.g., an unlicensed RF spectrum band). For example, uplink messages in a licensed band may be scheduled (e.g., by a network entity), such that the UE transmits an uplink message on one or more allocated resources (e.g., frequency resources, time resources). In contrast, communications via shared bands may be based on listening procedures (e.g., listen-before-talk (LBT)) to access a channel and transmit messages. Thus, the UE may not know whether a shared band is available for transmission of an uplink message, or if other transmissions occupying the shared band may interfere or collide with the uplink message.

Accordingly, the techniques described herein support performing uplink switching between an uplink licensed band and an uplink shared band, which may increase signaling throughput, spectral efficiency, and resource utilization. A UE configured to communicate via a licensed band may receive a control message (e.g., a grant) from a network entity scheduling an uplink message to be transmitted via the licensed band. The UE may perform one or more listening procedures to determine or otherwise detect whether resources of a shared band are available. If the shared band has available resources, the UE may perform uplink transmit switching and may transmit the uplink message via the shared band. For instance, the UE may transmit the uplink message in accordance with a subset of scheduling parameters indicated in the control message. The network entity may monitor both the shared band and the licensed band for the uplink message. In some cases, the network entity may infer that the uplink transmit switching procedure of the UE was successful based on receiving the uplink message via the shared band.

Aspects of the disclosure are initially described in the context of wireless communications systems. Aspects of the disclosure are then discussed with reference to a switching timeline and a process flow. Aspects of the disclosure are further illustrated by and described with reference to apparatus diagrams, system diagrams, and flowcharts that relate to uplink transmission switching for unlicensed bands.

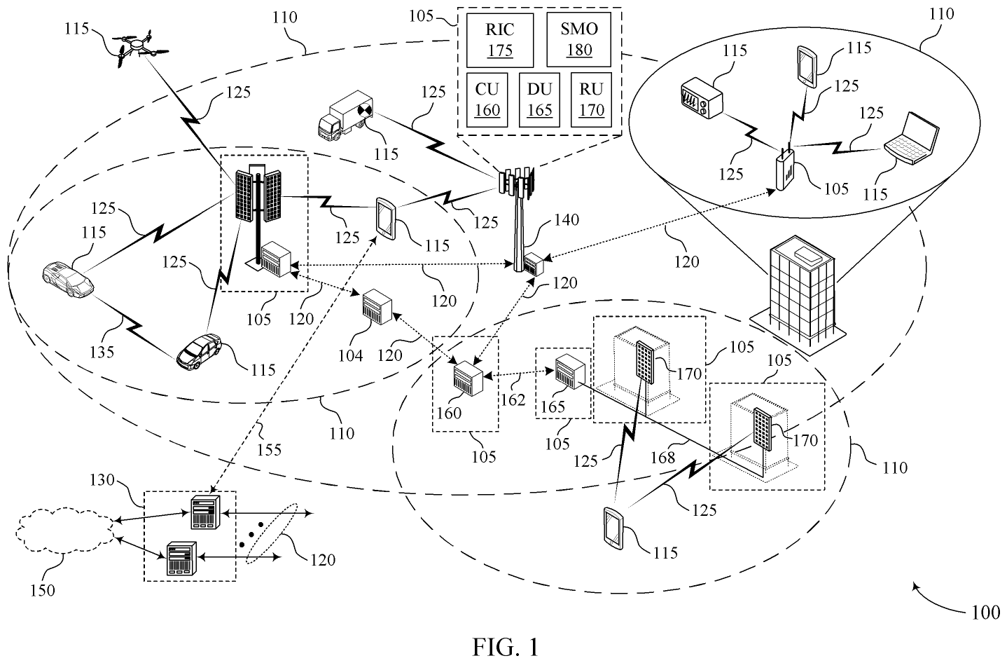

FIG. 1 illustrates an example of a wireless communications system 100 that supports uplink transmission switching for unlicensed bands in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for inter-UE coordination-based sidelink communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a UE 115 may perform uplink transmit switching between two bands, for example, two different frequency bands. In some cases, enabling the UE 115 to perform uplink transmit switching dynamically may increase uplink throughput. For example, if the UE 115 is able to use multiple bands to perform a transmission, the UE 115 may switch to a band that has less traffic or is associated with a relatively high quality. Additionally, or alternatively, the UE 115 may simultaneously perform multiple transmissions on respective frequency bands.

In some cases, to reduce usage of limited bandwidth availability in licensed RF spectrum bands, devices in the wireless communications system 100 may communicate in an unlicensed RF spectrum band (also referred to as a shared RF spectrum band, a shared band, an unlicensed band, or the like), which may have relatively large bandwidths available. However, the unlicensed RF spectrum band may be shared with other technologies (e.g., wireless local area network (WLAN) systems, such as Wi Fi). Additionally, access to the unlicensed RF spectrum band may be regulated. Accordingly, devices operating in the unlicensed RF spectrum band may perform channel access (e.g., a channel access procedure, such as an LBT) prior to transmitting in the unlicensed RF spectrum band.

According to the techniques described herein, a UE 115 may perform uplink transmit switching (also referred to as uplink switching) between a licensed RF spectrum band and an unlicensed RF spectrum band. Switching between licensed and unlicensed bands may enable the UE 115 to communicate with improved throughput and reduced latency. For example, the UE 115 may receive (e.g., from a network entity 105) a grant scheduling an uplink message via the licensed RF spectrum band, but may perform uplink transmit switching to switch to and transmit the uplink message via the unlicensed RF spectrum band. To avoid collisions or interference with occupied resources of the unlicensed RF spectrum band, the UE 115 may determine whether any available resources exist in the unlicensed RF spectrum band that the UE 115 can use for transmission of the uplink message. That is, before switching an RF chain configuration, the UE 115 may perform one or more listening procedures to sense a channel of the unlicensed RF spectrum band. The UE 115 may determine which, if any, resources (e.g., time resources, frequency resources) of the unlicensed RF spectrum band are available to use for transmissions (e.g., to the network entity 105) based on a result of the one or more listening procedures. If sufficient resources are available (e.g., unoccupied by other transmissions or devices), the UE 115 may switch to the unlicensed RF spectrum band and may transmit the uplink message via the unlicensed RF spectrum band in accordance with the grant.

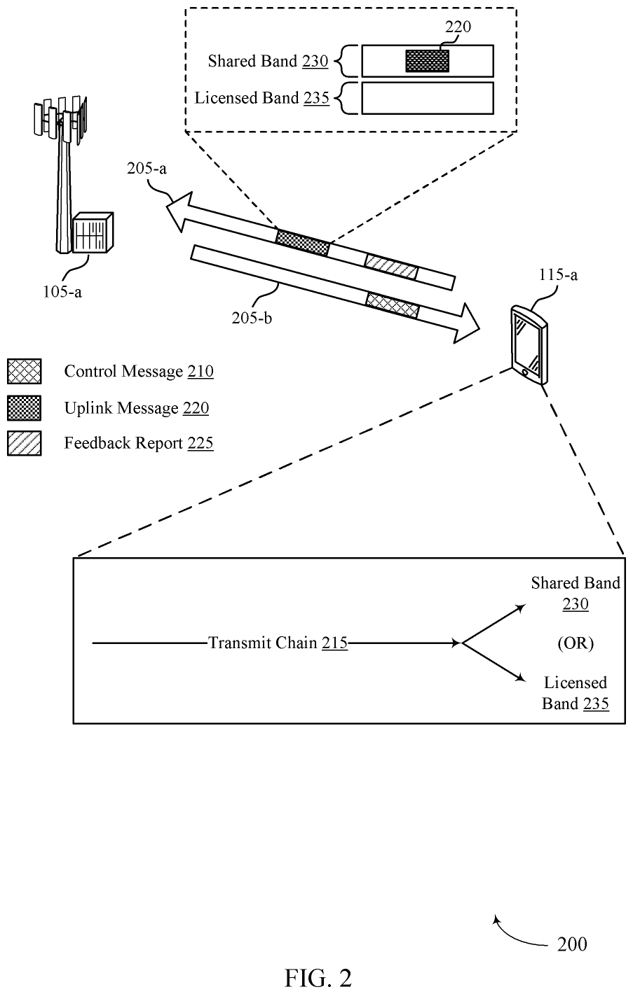

FIG. 2 illustrates an example of a wireless communications system 200 that supports uplink transmission switching for unlicensed bands in accordance with one or more aspects of the present disclosure. In some examples, the wireless communications system 200 may implement aspects of the wireless communications system 100. For example, the wireless communications system 200 may include a network entity 105-a and a UE 115-a, which may be examples of corresponding devices described herein.

The wireless communications system 200 may support communications between the network entity 105-a and the UE 115-a. For example, the network entity 105-a may communicate signals (e.g., uplink and downlink transmissions) with the UE 115-a over respective communication links 205, which may be examples of communication links 125 described with reference to FIG. 1.

The UE 115-a may be capable of performing uplink transmissions using one or more of a shared band 230 (which may also be referred to as an unlicensed RF spectrum band), a licensed band 235 (which may also be referred to as a licensed RF spectrum band), or the shared band 230 and the licensed band 235 simultaneously. That is, the UE 115-a may be configured to perform one uplink transmission on one band at a time or simultaneous uplink transmissions on multiple bands. In some cases, the UE 115-a may be capable of performing simultaneous uplink transmissions on two bands (e.g., the shared band 230 and the licensed band 235).

To support uplink transmissions via multiple bands, the UE 115-a may be capable of performing uplink switching between the shared band 230 and the licensed band 235. The UE 115-a may be configured to support one or more transmit chains (e.g., transmit RF chains), such as a transmit chain 215. In the example of the wireless communications system 200, the transmit chain 215 may be configured to support communications on the shared band 230 and the licensed band 235. That is, the transmit chain 215 may be changeably configured to support, at any given time, an uplink transmission via the shared band 230 or the licensed band 235. The UE 115-a may perform uplink switching by switching a configuration of the transmit chain 215, e.g., from a configuration for the shared band 230 to a configuration for the licensed band 235 or vice versa.

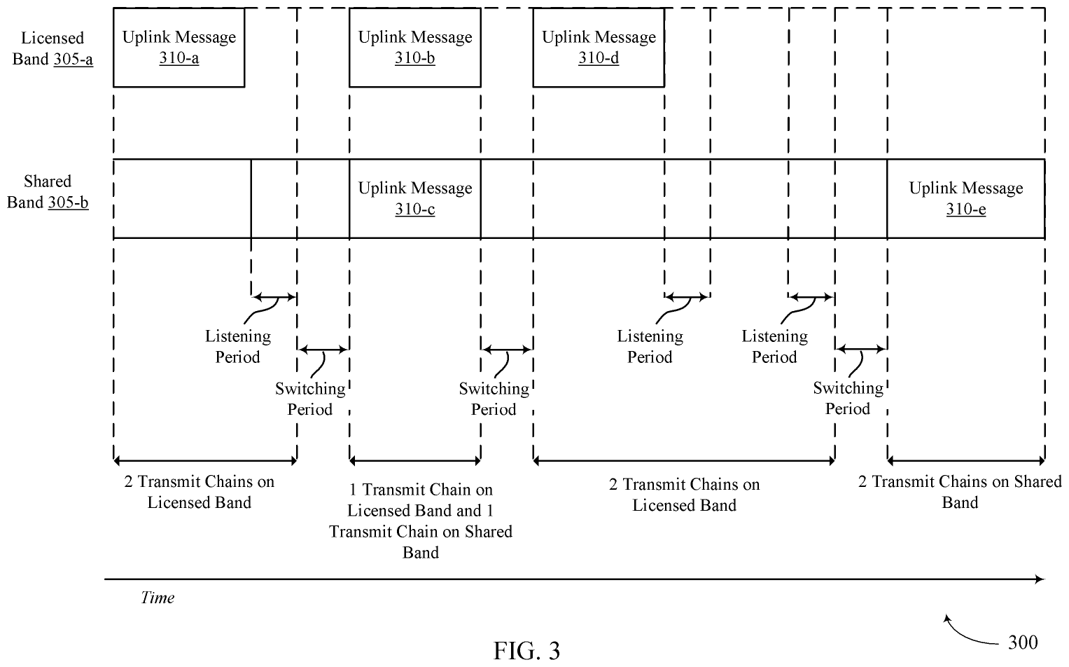

It should be noted that the example of FIG. 2 illustrating a single transmit chain 215 for the UE 115-a is not limiting, and the techniques described herein may be applicable to any number of transmit chains 215. For instance, as described with reference to FIG. 3, the UE 115-a may have two transmit chains configured to communicate via any combination of the shared band 230 and the licensed band 235. That is, a first transmit chain and a second transmit chain may be changeably configured to support, at any given time, a one-port transmission, a two-port transmission, or no transmission on the shared band 230 and the licensed band 235. The UE 115-a may perform uplink switching between the shared band 230 and the licensed band 235 by switching configurations of one or both transmit chains.

The network entity 105-a may schedule uplink transmissions at the UE 115-a by transmitting a control message 210 (e.g., downlink control information (DCI)) indicating a scheduling grant. For example, the UE 115-a may be configured to communicate via the licensed band 235. The UE 115-a may receive the control message 210 (e.g., an uplink grant) from the network entity 105-a scheduling an uplink message 220 for transmission via the licensed band 235 over a set of one or more transmit ports of the UE 115-a. The control message 210 may indicate a set of scheduling parameters for transmission of the uplink message 220. For example, the set of scheduling parameters may indicate a quantity of transmission layers (e.g., a transmission rank), a precoder, a set of resources (e.g., time resources, frequency resources, or both) of the licensed band 235, one or more other transmission parameters, or any combination thereof, for the uplink message 220.

The UE 115-a may perform uplink transmit switching to switch a transmit chain 215 of the UE 115-a from the shared band 230 to the licensed band 235. For example, although the uplink message 220 may be scheduled for the licensed band 235, the shared band 230 may be accessible by the UE 115-a. The UE 115-a may determine to transmit the uplink message 220 via the shared band 230, e.g., instead of or in addition to transmitting the uplink message 220 via the licensed band 235. In some examples, the UE 115-a may be triggered to perform uplink switching, for example, by the network entity 105-a. For instance, the control message 210 may additionally or alternatively indicate that the UE 115-a is to perform uplink transmit switching to switch a transmit chain 215 to the shared band 230, or that the UE 115-a is to transmit the uplink message 220 via the licensed band 235, the shared band 230, or a combination thereof. In some cases, the control message 210 may instruct (e.g., trigger) the UE 115-a to perform uplink transmit switching from the licensed band 235 to the shared band 230 if the shared band 230 is available (e.g., if a listening procedure by the UE 115-a for the shared band 230 is successful).

In some cases, the network entity 105-a may schedule, via the control message 210 (e.g., and one or more additional control messages), up to two uplink messages including the uplink message 220. For example, the network entity 105-a may schedule both uplink messages for the licensed band 235. Alternatively, the network entity 105-a may, via the control message 210, schedule a first uplink message for the licensed band 235 and instruct the UE 115-a to transmit a second uplink message via the shared band 230, such that the UE 115-a performs uplink switching of one transmit chain to transmit the second uplink message. In another example, the control message 210 may indicate or otherwise trigger the UE 115-a to perform uplink transmit switching to attempt to transmit one or both uplink messages via the shared band 230.

In the example of FIG. 2, the UE 115-a may perform uplink switching for the transmit chain 215 to transmit the uplink message 220 via the shared band 230. To avoid interference or collisions with other transmissions on the shared band 230, the UE 115-a may perform one or more listening procedures for the shared band 230 to determine whether shared resources are available for transmission of the uplink message 220. For example, the UE 115-a may sense the shared band 230 by measuring an energy level of the shared band 230 during a listening period. If the energy level is below a threshold, the UE 115-a may determine that the shared band 230 (e.g., shared resources of the shared band 230) is available for use by the UE 115-a. Detection of available shared resources may correspond to a success result of a listening procedure. Alternatively, if the UE 115-a fails to detect any available resources or otherwise determines that the shared band 230 is occupied, the listening procedure may be considered unsuccessful (e.g., corresponding to a failure result of the listening procedure).

The UE 115-a may perform the one or more listening procedures for the shared band 230 prior to performing uplink transmit switching to the shared band 230. For example, the UE 115-a may refrain from switching to the shared band 230 until the UE 115-a confirms that there are resources of the shared band 230 available for the uplink transmission (e.g., via the one or more listening procedures). In some cases, the UE 115-a may initiate the one or more listening procedures based on receiving the control message 210. Based on a result of the one or more listening procedures, the UE 115-a may perform uplink transmit switching to switch the transmit chain 215 from the licensed band 235 to the shared band 230. For example, the UE 115-a may switch to the shared band 230 if the one or more listening procedures are successful, or may refrain from switching to the shared band 230 if the one or more listening procedures fail.

In some examples, the UE 115-a may be configured with a processing time to prepare for an uplink transmission, such as the uplink message 220. The processing time may be referred to as a physical uplink shared channel (PUSCH) preparation time and may be defined as a minimum time needed by the UE 115-a to decode the control message 210 and prepare the uplink message 220. The PUSCH preparation time may include one or more configured processing durations and may be based on one or more capabilities (e.g., processing capabilities) of the UE 115-a. Additionally, as described with reference to FIG. 3, the PUSCH preparation time may include a listening period during which the UE 115-a performs the one or more listening procedures and a switching period during which the UE 115-a switches the transmit chain 215. The switching period may begin once the UE 115-a has detected one or more available resources on the shared band 230. That is, an end time of the listening period may coincide with a start time of the switching period if the one or more listening procedures are successful.

Based on performing the switching, the UE 115-a may transmit the uplink message 220 to the network entity 105-a via the shared band 23. The network entity 105-a may monitor both the shared band 230 and the licensed band 235 to receive the uplink message 220. For example, the network entity 105-a may be aware that the UE 115-a may attempt to switch uplink bands, and may monitor both the shared band 230 and the licensed band 235 to ensure reception of the uplink message 220 regardless of whether the uplink switching at the UE 115-a was successful.

Additionally, in some examples and based on the switching, the UE 115-a may transmit a message (e.g., a physical uplink control channel (PUCCH) message) to the network entity 105-a that includes a feedback report 225. If the UE 115-a finds available resources on the shared band 230 for the uplink message 220 and switches the transmit chain 215 from the licensed band 235 to the shared band 230, the feedback report 225 may include an acknowledgment (ACK) message. That is, the UE 115-a may transmit a feedback report 225 to the network entity 105-a associated with the uplink message 220, where the feedback report 225 indicates that the switching, the one or more listening procedures, or both, were successful. In some cases, the network entity 105-a may monitor the shared band 230 based on receiving an ACK in the feedback report 225. Alternatively, if the UE 115-a fails to detect available resources on the shared band 230 for transmission of the uplink message 220 and does not switch the transmit chain 215, the UE 115-a may report a negative acknowledgment (NACK). For example, the UE 115-a may transmit the feedback report 225 associated with the uplink message 220 indicating that the switching, the one or more listening procedures, or both, were not successful (e.g., failed).

In some examples, the UE 115-a may not transmit a feedback report 225. The network entity 105-a may determine whether the switching or the one or more listening procedures at the UE 115-a were successful based on whether the network entity 105-a receives the uplink message 220 via the shared band 230 or the licensed band 235. For example, if the network entity 105-a receives the uplink message 220 via the licensed band 235, the network entity 105-a may assume that the switching or the one or more listening procedures at the UE 115-a failed. If the network entity 105-a receives the uplink message 220 via the shared band 230, the network entity 105-a may determine that the switching or the one or more listening procedures at the UE 115-a were successful. In some cases, the network entity 105-a may assume a failure result for the switching or the one or more listening procedures at the UE 115-a if the network entity 105-a does not receive the uplink message 220 at all. For example, the UE 115-a may transmit the uplink message 220 via the shared band 230, but the uplink message 220 may collide or suffer interference from other transmissions on the shared band 230 and may fail to reach the network entity 105-a.

FIG. 3 illustrates an example of a switching timeline 300 that supports uplink transmission switching for shared band 305-bs in accordance with one or more aspects of the present disclosure. In some examples, the carrier switching timeline 300 may implement or be implemented by aspects of the wireless communications systems 100 and 200. For example, the carrier switching timeline 300 illustrates a timeline for a UE to switch between a licensed band 305-a and a shared band 305-b for communications with a network entity. The UE and the network entity may represent examples of corresponding devices as described with reference to FIGS. 1 and 2 herein. The UE may perform uplink carrier switching between the licensed band 305-a and the shared band 305-b to transmit one or more uplink messages 310 to the network entity. The network entity may monitor both the shared band 305-b and the licensed band 305-a to receive the uplink messages 310.

The UE may be configured with one or more transmit chains, as described with reference to FIG. 2. In the example of FIG. 3, the UE may include two transmit chains (e.g., a first transmit chain and a second transmit chain), which may be changeably configured to support, at any given time, a one-port transmission, a two-port transmission, or no transmission on the shared band 305-b and the licensed band 305-a. For example, the first transmit chain may be configured to communicate via the shared band 305-b and the second transmit chain may be configured to communicate via the licensed band 305-a. Alternatively, the first transmit chain and the second transmit chain may both be configured to communicate via the shared band 305-b or via the licensed band 305-a.

An RF status of the UE may refer to the configuration of the transmit chains with respect to being tuned to the shared band 305-b, the licensed band 305-a, or a combination thereof, which may additionally or alternatively be referred to as a transmit chain configuration. The RF status and/or transmit chain configuration of the UE may refer to the configuration of the first transmit chain, the second transmit chain, or both with respect to whether they are configured for a one antenna port transmission, a two antenna port transmission, or both on the shared band 305-b, the licensed band 305-a, or both.

The UE may support uplink transmit chain switching between the shared band 305-b and the licensed band 305-a by modifying or changing the transmit chain configuration. During uplink transmit chain switching, the UE may switch configurations of the first transmit chain, the second transmit chain, or both. The switching timeline 300 illustrates a timeline, including switching periods (e.g., uplink switching periods) and listening periods, for a UE to perform switching between uplink messages 310 on the shared band 305-b and uplink messages 310 on the licensed band 305-a.

In the example of FIG. 3, the UE may transmit an uplink message 310-a to the network entity via the licensed band 305-a. At the time of transmission of the uplink message 310-a, both the first transmit chain and the second transmit chain may be configured to transmit via the licensed band 305-a. As described with reference to FIG. 2, after transmission of the uplink message 310-a, the UE may determine to switch a transmit chain, such as the first transmit chain, to the shared band 305-b. For example, the UE may be triggered to perform uplink switching by the network entity, or the UE may have an uplink message 310-c that is to be transmitted via the shared band 305-b. Additionally, or alternatively, the UE may receive a control message scheduling an uplink message 310-b via the licensed band 305-a and indicating that the UE is to transmit the uplink message 310-c via the shared band 305-b. In another example, the UE may receive a control message scheduling the uplink message 310-b via the licensed band 305-a and may determine to attempt transmission of the uplink message 310-c via the shared band 305-b at the same time. In this example, the uplink message 310-c may have a same payload as the uplink message 310-b. That is, the UE may transmit repetitions of an uplink message 310 via each of the shared band 305-b and the licensed band 305-a, which may improve reliability and robustness.

In any case, the UE may perform one or more listening procedures to determine whether resources of the shared band 305-b (also referred to as shared resources) are available for the uplink message 310-c. A time duration or a symbol duration during which the UE performs one or more listening procedures may be referred to as a listening period. A start time of the listening period may refer to a time at which the UE begins the one or more listening procedures, and an end time of the listening period may refer to a time at which the UE ends the one or more listening procedures and determines a result (e.g., whether the one or more listening procedures were successful and indicated one or more available resources, or failed and detected no available resources).

Additionally, a switching period (or gap) for the UE to retune its RF components (e.g., RF status) to switch a transmit chain may be required between uplink messages 310. Retuning or otherwise reconfiguring the RF status (e.g., the current RF status) of the UE may refer to retuning or reconfiguring the first transmit chain, the second transmit chain, or both between a one antenna port transmission and a two antenna port transmission on the shared band 305-b and/or the licensed band 305-a, or vice versa. For example, during a switching period, the UE may switch the first transmit chain from the licensed band 305-a to the shared band 305-b to transmit the uplink message 310-c. The UE may keep the second transmit chain configured to the licensed band 305-a for transmission of the uplink message 310-b. A start time of the switching period may correspond to the UE detecting that one or more shared resources of the shared band 305-b are available for an uplink message 310 (e.g., the uplink message 310-c), and an end time of the switching period may correspond to transmission of the uplink message 310 e.g., the uplink message 310-c) via the shared band 305-b.

The UE may be configured with a processing time to prepare for an uplink message 310. The processing time may be referred to as a PUSCH preparation time. The PUSCH preparation time may include one or more configured processing durations. The UE may calculate the PUSCH preparation time for an uplink message 310 using Equation 1 below.

$$( 1 )$$

$${T}_{proc , 2} = max ( ( {N}_{2} + {d}_{2 , 1} + {d}_{2} ) ( 2048 + 1 \; 44 ) \cdot {κ2}^{- μ} \cdot {T}_{C} + {T}_{ext} + {T}_{switch} , {d}_{2 , 2} )$$

The T_{switch} parameter in Equation 1 may represent the switching period. If uplink transmit chain switching is not configured for the UE, the T_{switch} parameter may be zero. The u parameter may correspond to a subcarrier spacing (SCS) value associated with a downlink communication link in which a control message (e.g., a physical downlink control channel (PDCCH) carrying DCI) that schedules an uplink message 310 (e.g., a PUSCH) was transmitted. The N2 parameter may be determined based on the value of u and a processing capability of the UE (e.g., UE processing capability 1 or 2). The d_{2,1} parameter may be zero if a first symbol of a PUSCH allocation indicated in the control message (e.g., for the uplink message) includes a demodulation reference signal (DMRS) allocation. If the first symbol of the PUSCH allocation includes allocations different than DMRS, d_{2,1} may be set to one. The d_{2,2} parameter may be set to a switching time for bandwidth part (BWP) switching if BWP switching is triggered (e.g., if a scheduling DCI triggers BWP switching). If BWP switching is not triggered, d_{2,2} may be zero. The d₂ parameter may be reported by the UE if a PUSCH of a larger priority index is to overlap with a PUCCH of a smaller priority index. Otherwise, d₂ may be set to zero. The Tₑₓₜ parameter may be calculated for an operation with shared spectrum channel access. Otherwise, Tₑₓₜ may be set to zero. The K and Tc parameters may be constants.

According to the present disclosure, the PUSCH preparation time for uplink switching between a shared band 305-b and a licensed band 305-a may further include a listening period corresponding to one or more listening procedures performed by the UE. The listening period may be represented as a time duration, for example, in microseconds (μs). In such cases, the UE may calculate the PUSCH preparation time according to Equation 2 below, where the listening period in us is given by Tₗᵢₛₜₑₙ.

$${T}_{proc , 2} = max ( ( {N}_{2} + {d}_{2 , 1} + {d}_{2} ) ( 2048 + 1 \; 44 ) \cdot {κ2}^{- μ} \cdot {T}_{C} + {T}_{ext} + {T}_{switch} + {T}_{listen} , {d}_{2 , 2} ) \qquad ( 2 )$$

Alternatively, the listening period may be represented as a symbol duration (e.g., a quantity of symbols). In this example, the UE may calculate the PUSCH preparation time according to Equation 3 below, where the listening period in symbols is given by d₃.

$${T}_{proc , 2} = max ( ( {N}_{2} + {d}_{2 , 1} + {d}_{2} + {d}_{3} ) ( 2048 + 1 \; 44 ) \cdot {κ2}^{- μ} \cdot {T}_{C} + {T}_{ext} + {T}_{switch} , {d}_{2 , 2} ) \qquad ( 3 )$$

As illustrated in FIG. 3, the UE may prepare the uplink message 310-c during a preparation time calculated according to Equation 2 or Equation 3. For example, the UE may perform one or more listening procedures during a listening period to detect available resources of the shared band 305-b. The UE may sense a channel associated with the shared band 305-b to determine whether upcoming resources (e.g., in the time domain) are occupied or are available for the UE to use for the uplink message 310-c. The one or more listening procedures may be successful, such that the UE detects one or more shared resources available for transmission of the uplink message 310-c via the shared band 305-b. Based on the success result, the UE may perform uplink switching during a switching period to switch to the shared band 305-b (e.g., the UE may switch the first transmit chain to the shared band 305-b) for transmission of the uplink message 310-c.

In some examples, the UE may operate according to a transmit chain configuration that supports concurrent transmissions on the shared band 305-b and the licensed band 305-a. For example, if the first transmit chain of the UE is active on the shared band 305-b and the second transmit chain of the UE is active on the licensed band 305-a, the UE may support simultaneous transmission on each band. The UE may simultaneously transmit the uplink message 310-b via the licensed band 305-a (e.g., in accordance with a grant) and the uplink message 310-c via the shared band 305-b over the one or more available resources detected during the one or more listening procedures.

After performing transmission of the uplink messages 310-b and 310-c, the UE may subsequently switch the first transmit chain back to the licensed band 305-a during another switching period. The UE may transmit an uplink message 310-d via the licensed band 305-a using a single transmit chain (e.g., the first transmit chain or the second transmit chain) or using both transmit chains. After transmission of the uplink message 310-d, the UE may again initiate an uplink switching procedure to switch to the shared band 305-b for transmission of an uplink message 310-e by performing one or more listening procedures for the shared band 305-b during a listening period. Here, however, the UE may fail to detect any upcoming available resources on the shared band 305-b (e.g., the one or more listening procedures may fail). Accordingly, the UE may not perform uplink switching and may maintain both the first transmit chain and the second transmit chain in configurations for the licensed band 305-a. The UE may not transmit the uplink message 310-d at this time based on the failure of the one or more listening procedures. In some cases, if the network entity was expecting to receive the uplink message 310-d, the network entity may assume that the one or more listening procedures and the associated switching procedure at the UE were not successful.

In some examples, after some time has passed, the UE may reattempt the one or more listening procedures during a listening period to determine whether any upcoming resources are now available on the shared band 305-b. Upon detection of one or more available resources, the UE may initiate the uplink switching procedure by switching the first transmit chain and the second transmit chain to the shared band 305-b. After the associated switching period, the UE may transmit the uplink message 310-e to the network entity using both transmit chains.

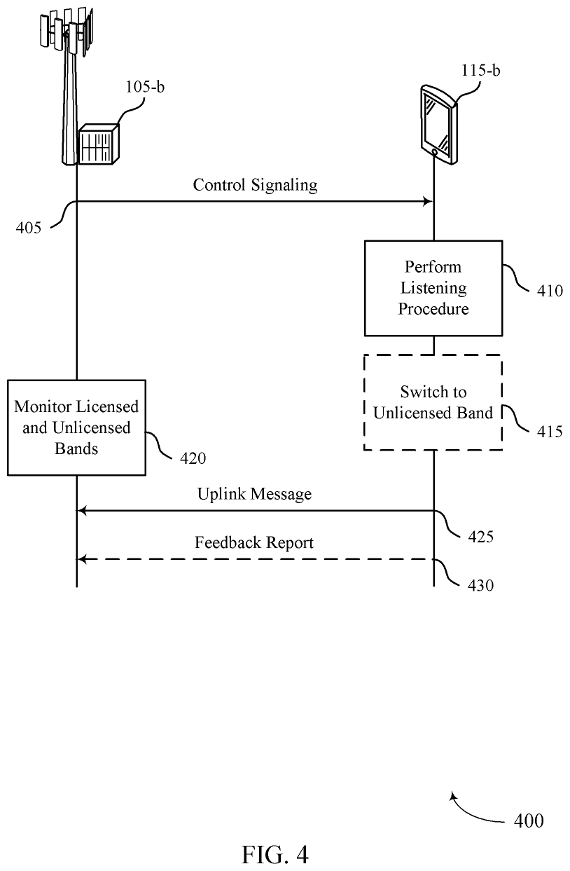

FIG. 4 illustrates an example of a process flow 400 that supports uplink transmission switching for unlicensed bands in accordance with one or more aspects of the present disclosure. The process flow 400 may implement or be implemented by some aspects of the wireless communications system 100 or 200 or the carrier switching timeline 300. For example, the process flow 400 may include a UE 115-b and a network entity 105-b, which may be examples of a UE 115 and a network entity 105 as described with reference to FIGS. 1-3. The UE 115-b may be configured with up to two transmit RF chains as described herein, where each transmit RF chain is configured to communicate via an RF spectrum band. For example, the UE 115-b may include two transmit RF chains configured to communicate with the network entity 105-b via a licensed band.

It is understood that the devices and nodes described by the process flow 400 may communicate with or be coupled with other devices or nodes that are not illustrated. For example, the UE 115-b and the network entity 105-b may communicate with one or more other UEs 115, base stations 105, or other devices. Alternative examples of the following may be implemented, where some steps are performed in a different order than described or are not performed at all. In some cases, a step may include additional features not mentioned below, or further steps may be added.

At 405, the network entity 105-b may transmit, and the UE 115-b may receive, control signaling indicating a set of scheduling parameters for the UE 115-b to use to transmit an uplink message via the licensed band. The control signaling may include a grant scheduling resources of the licensed band for the uplink message. In some examples, the control signaling (e.g., the grant) may additionally or alternatively indicate that the UE 115-b is to transmit the uplink message via the licensed band, an unlicensed band, or a combination thereof. For example, the grant may instruct (e.g., trigger) the UE 115-b to perform uplink transmit switching from the licensed band to the unlicensed band if the unlicensed band is available (e.g., if a listening procedure by the UE 115-b for the unlicensed band is successful).

In some cases, the network entity 105-b may schedule, via the control signaling (e.g., the grant), up to two uplink messages. For example, the grant may schedule both uplink messages for the licensed frequency band, or may schedule one uplink message for the licensed frequency band and instruct the UE 115-b to transmit the other uplink message via the unlicensed band (e.g., if available and based on an uplink transmit switching procedure at the UE 115-b), or may instruct (e.g., trigger) the UE 115-b to perform uplink transmit switching to attempt to transmit both uplink messages via the unlicensed band.

At 410, based on the control signaling, the UE 115-b may perform one or more listening procedures (e.g., channel access procedures) for the unlicensed band to determine or otherwise detect whether resources of the unlicensed band (e.g., shared resources) are available for the uplink message. That is, the UE 115-b may perform the one or more listening procedures to determine whether to perform uplink transmit switching with one or both transmit RF chains to transmit the uplink message via the unlicensed band. In some cases, the UE 115-b may perform the one or more listening procedures based on being triggered by the network entity 105-b to initiate an uplink transmit switching procedure (e.g., to the unlicensed band). The trigger may be indicated via the control signaling at 405 or another message received from the network entity 105-b.

During the one or more listening procedures, the UE 115-b may listen to (e.g., sense) one or more channels of the unlicensed band to determine whether upcoming (e.g., subsequent in time) shared resources are occupied or available. In some cases, the UE 115-b may sense a quantity of shared resources based on the set of scheduling parameters indicated by the control signaling. For example, the set of scheduling parameters may indicate a quantity of time resources to be used for transmission of the uplink message, and the UE 115-b may perform the one or more listening procedures to determine if the quantity of time resources are available in the unlicensed band, e.g., if the unlicensed band has sufficient shared resources free to transmit the uplink message.

A success result of the one or more listening procedures may correspond to the UE 115-b detecting or otherwise determining that one or more shared resources of the unlicensed band are available (e.g., unoccupied) for transmission of the uplink message. Alternatively, a failure result of the one or more listening procedures may correspond to the UE 115-b detecting or otherwise determining that one or more shared resources of the unlicensed band are occupied, e.g., that there are no available shared resources for transmission of the uplink message.

Based on a result (e.g., a success result or a failure result) of the one or more listening procedures, the UE 115-b may determine to switch to the unlicensed band for transmission of the uplink message or to refrain from switching to the unlicensed band. For example, at 415, if the one or more listening procedures were successful, the UE 115-b may perform uplink transmit switching by switching at least one transmit RF chain (e.g., a configuration of at least one transmit RF chain) to the unlicensed band. That is, the UE 115-b may switch at least one transmit RF chain to the unlicensed band if the UE 115-b determines, via the one or more listening procedures, that one or more shared resource of the unlicensed band are available. Alternatively, if the one or more listening procedures at 410 were unsuccessful (e.g., failed), the UE 115-b may refrain from performing uplink transmit switching, such that the at least one transmit RF chains remain configured for communications via the licensed band.

In some examples, the uplink transmit switching may be performed at 415 according to a preparation time (e.g., a PUSCH preparation time). The preparation time may be defined as a time duration between receiving the control signaling at the UE 115-b (e.g., at 405) and transmission of the uplink message by the UE 115-b (e.g., at 420), and may be represented by Equation 1 or Equation 2 as discussed with reference to FIG. 3. In some examples, the preparation time may begin at initiation of the one or more listening procedures, such that the preparation time includes a listening period. The listening period may be defined as a time duration (e.g., in μs) or a symbol duration (e.g., in a quantity of symbols). Additionally, the preparation time may include a switching period between bands for the UE 115-b and may be based on one or more capabilities of the UE 115-b. A start time of the switching period between bands may correspond to the time at which the UE 115-b detects that the one or more shared resources of the unlicensed band are available, while an end time of the switching period may correspond to the time at which the UE 115-b completes switching of the transmit RF chain(s) and begins transmission of the uplink message.

At 420, the network entity 105-b may monitor the licensed band and the unlicensed band for the uplink message from the UE 115-b.

At 425, UE 115-b may transmit, and the network entity 105-b may receive, the uplink message in accordance with at least a portion of the set of scheduling parameters and based on the result of the one or more listening procedures. For example, if the one or more listening procedures were successful such that the UE 115-b performed uplink transmit switching at 415, the UE 115-b may transmit the uplink message via the one or more shared resources of the unlicensed band. Here, the UE 115-b may transmit the uplink message in accordance with the portion of the set of scheduling parameters. For instance, the UE 115-b may utilize a transmit power, MCS, or the like, indicated by the control signaling at 405 for transmission of the uplink message via the unlicensed band. However, the UE 115-b may disregard or discard other scheduling parameters, such as a resource allocation specific to the licensed band. In some examples, the UE 115-b may perform uplink transmit switching to switch back to the licensed band after transmitting the uplink message via the unlicensed band.

Alternatively, if the one or more listening procedures failed, such that the UE 115-b did not perform uplink transmit switching at 415, the UE 115-b may transmit the uplink message via the licensed band in accordance with at least the portion of the set of scheduling parameters (e.g., the entire set of scheduling parameters). The network entity 105-b may receive the uplink message based on monitoring both the licensed band and the unlicensed band at 420.

At 430, in some examples, the UE 115-b may optionally report whether the one or more listening procedures, and subsequently, the uplink transmit procedure, were successful. The UE 115-b may transmit, and the network entity 105-b may receive, a feedback report (e.g., via the licensed band or the unlicensed band) associated with the uplink message based on the result of the one or more listening procedures. For example, when the one or more listening procedures are successful, the UE 115-b may transmit the feedback report that includes or is an example of an acknowledgement (e.g., an ACK) associated with transmitting the uplink message via the one or more shared resources of the unlicensed band. Alternatively, if the one or more listening procedures failed, the UE 115-b may transmit the feedback report that includes or is an example of a negative acknowledgement (e.g., a NACK).

In other examples, the UE 115-b may implicitly report, and the network entity 105-b may infer, whether the one or more listening procedures (e.g., and the uplink transmit switching procedure) were successful. Here, the UE 115-b may not transmit a feedback message at 430. Instead, transmission of the uplink message in accordance with the portion of scheduling parameters via the unlicensed band may be considered an acknowledgement (e.g., an implicit indication of a success result) such that the network entity 105-b may infer or otherwise determine that the one or more listening procedures and the uplink transmit switching procedure at the UE 115-b were successful. If the network entity 105-b fails to receive the uplink message (e.g., via the licensed band or the unlicensed band), the network entity 105-b may infer or otherwise determine that the one or more listening procedures and the uplink transmit switching procedure at the UE 115-b were not successful (e.g., failed).

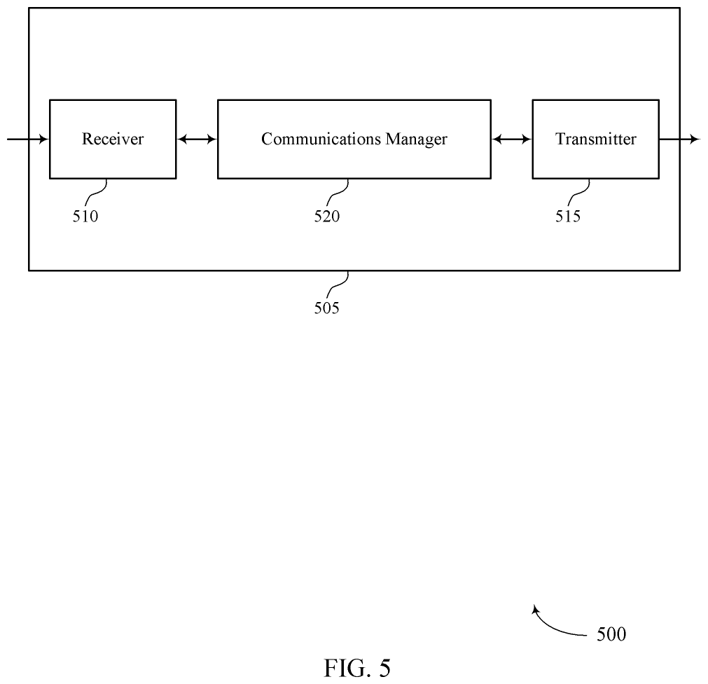

FIG. 5 illustrates a block diagram 500 of a device 505 that supports uplink transmission switching for unlicensed bands in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to uplink transmission switching for unlicensed bands). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to uplink transmission switching for unlicensed bands). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of uplink transmission switching for unlicensed bands as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 may be configured as or otherwise support a means for receiving a control message that indicates a set of scheduling parameters for transmission of an uplink message via a licensed RF spectrum band. The communications manager 520 may be configured as or otherwise support a means for performing, based on the set of scheduling parameters, one or more listening procedures for a shared RF spectrum band to detect whether shared resources are available for the uplink message. The communications manager 520 may be configured as or otherwise support a means for transmitting the uplink message via one or more shared resources of the shared RF spectrum band in accordance with at least a portion of the set of scheduling parameters based on a result of the one or more listening procedures.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for uplink transmit switching between licensed and unlicensed frequency bands. By enabling the device 505 to dynamically switch to and from an unlicensed frequency band, the techniques described herein may increase signaling throughput, improve spectral efficiency, and improve efficiency in resource utilization. Further, the device 505 may support concurrent uplink transmissions via one or both of the licensed and unlicensed bands, which may reduce latency and improve communication reliability.

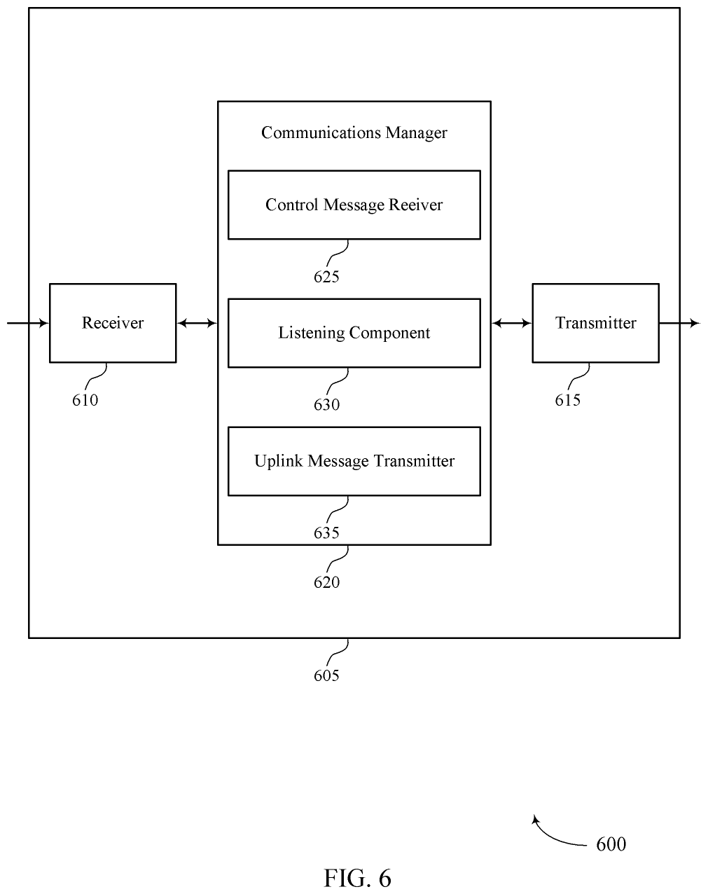

FIG. 6 illustrates a block diagram 600 of a device 605 that supports uplink transmission switching for unlicensed bands in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to uplink transmission switching for unlicensed bands). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to uplink transmission switching for unlicensed bands). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of uplink transmission switching for unlicensed bands as described herein. For example, the communications manager 620 may include a control message receiver 625, a listening component 630, an uplink message transmitter 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The control message receiver 625 may be configured as or otherwise support a means for receiving a control message that indicates a set of scheduling parameters for transmission of an uplink message via a licensed RF spectrum band. The listening component 630 may be configured as or otherwise support a means for performing, based on the set of scheduling parameters, one or more listening procedures for a shared RF spectrum band to detect whether shared resources are available for the uplink message. The uplink message transmitter 635 may be configured as or otherwise support a means for transmitting the uplink message via one or more shared resources of the shared RF spectrum band in accordance with at least a portion of the set of scheduling parameters based on a result of the one or more listening procedures.

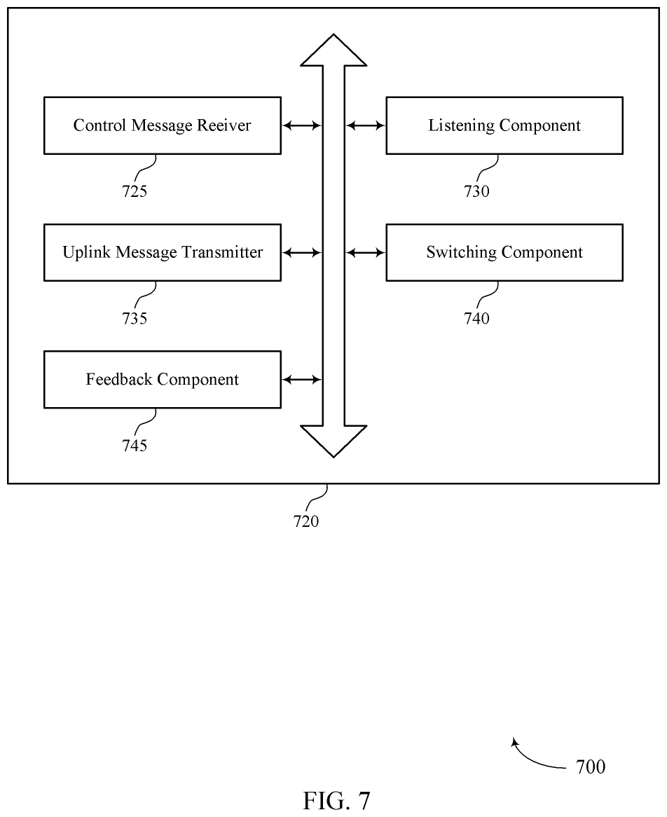

FIG. 7 illustrates a block diagram 700 of a communications manager 720 that supports uplink transmission switching for unlicensed bands in accordance with one or more aspects of the present disclosure. The communications manager 720 may be an example of aspects of a communications manager 520, a communications manager 620, or both, as described herein. The communications manager 720, or various components thereof, may be an example of means for performing various aspects of uplink transmission switching for unlicensed bands as described herein. For example, the communications manager 720 may include a control message receiver 725, a listening component 730, an uplink message transmitter 735, a switching component 740, a feedback component 745, or any combination thereof. Each of these components may communicate, directly or indirectly, with one another (e.g., via one or more buses).

The communications manager 720 may support wireless communications at a UE in accordance with examples as disclosed herein. The control message receiver 725 may be configured as or otherwise support a means for receiving a control message that indicates a set of scheduling parameters for transmission of an uplink message via a licensed RF spectrum band. The listening component 730 may be configured as or otherwise support a means for performing, based on the set of scheduling parameters, one or more listening procedures for a shared RF spectrum band to detect whether shared resources are available for the uplink message. The uplink message transmitter 735 may be configured as or otherwise support a means for transmitting the uplink message via one or more shared resources of the shared RF spectrum band in accordance with at least a portion of the set of scheduling parameters based on a result of the one or more listening procedures.

In some examples, to support transmitting the uplink message, the switching component 740 may be configured as or otherwise support a means for switching from the licensed RF spectrum band to the shared RF spectrum band based on the success result, where the uplink message is transmitted via the one or more shared resources based on the switching.

In some examples, the switching component 740 may be configured as or otherwise support a means for switching from the shared RF spectrum band to the licensed RF spectrum band after transmitting the uplink message.

In some examples, a preparation time between receiving the control message and transmitting the uplink message is based on a switching period between bands for the UE, one or more capabilities of the UE, and a listening period corresponding to the one or more listening procedures. In some examples, the listening period includes a time duration or a symbol duration. In some examples, a start time of the switching period corresponds to the UE detecting that the one or more shared resources of the shared RF spectrum band are available for the uplink message.

In some examples, the feedback component 745 may be configured as or otherwise support a means for transmitting a feedback report associated with the uplink message based on performing the one or more listening procedures. In some examples, to support transmitting the feedback report, the feedback component 745 may be configured as or otherwise support a means for transmitting an acknowledgement associated with transmitting the uplink message via the one or more shared resources of the shared RF spectrum band based on the result including a success result. In some examples, to support transmitting the feedback report, the feedback component 745 may be configured as or otherwise support a means for transmitting a negative acknowledgement based on the result including a failure result.

In some examples, up to two transmissions are scheduled for the licensed RF spectrum band and the shared RF spectrum band.

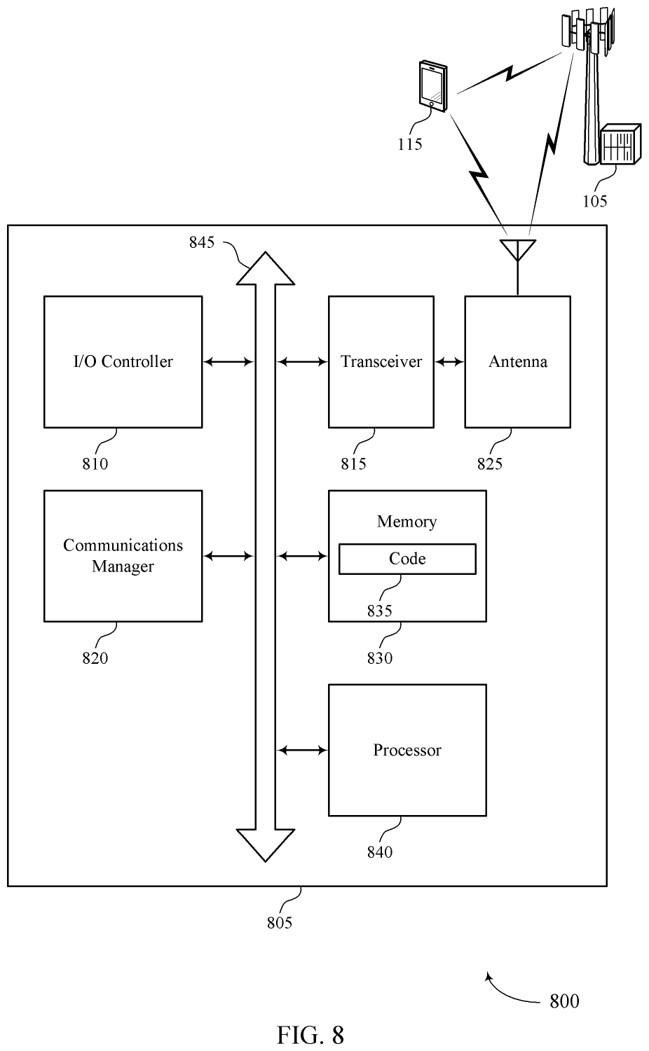

FIG. 8 illustrates a diagram of a system 800 including a device 805 that supports uplink transmission switching for unlicensed bands in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting uplink transmission switching for unlicensed bands). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for receiving a control message that indicates a set of scheduling parameters for transmission of an uplink message via a licensed RF spectrum band. The communications manager 820 may be configured as or otherwise support a means for performing, based on the set of scheduling parameters, one or more listening procedures for a shared RF spectrum band to detect whether shared resources are available for the uplink message. The communications manager 820 may be configured as or otherwise support a means for transmitting the uplink message via one or more shared resources of the shared RF spectrum band in accordance with at least a portion of the set of scheduling parameters based on a result of the one or more listening procedures.

By including or configuring the communications manager 820 in accordance with examples as described herein, the device 805 may support techniques for uplink transmit switching between licensed and unlicensed frequency bands. By enabling the device 805 to dynamically switch to and from an unlicensed frequency band, the techniques described herein may increase signaling throughput, improve spectral efficiency, and improve efficiency in resource utilization. Further, the device 805 may support concurrent uplink transmissions via one or both of the licensed and unlicensed bands, which may reduce latency and improve communication reliability. Enabling the device 805 to utilize an unlicensed band for uplink communications may also reduce usage of limited bandwidth availability in licensed bands.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of uplink transmission switching for unlicensed bands as described herein, or the processor 840 and the memory 830 may be otherwise configured to perform or support such operations.

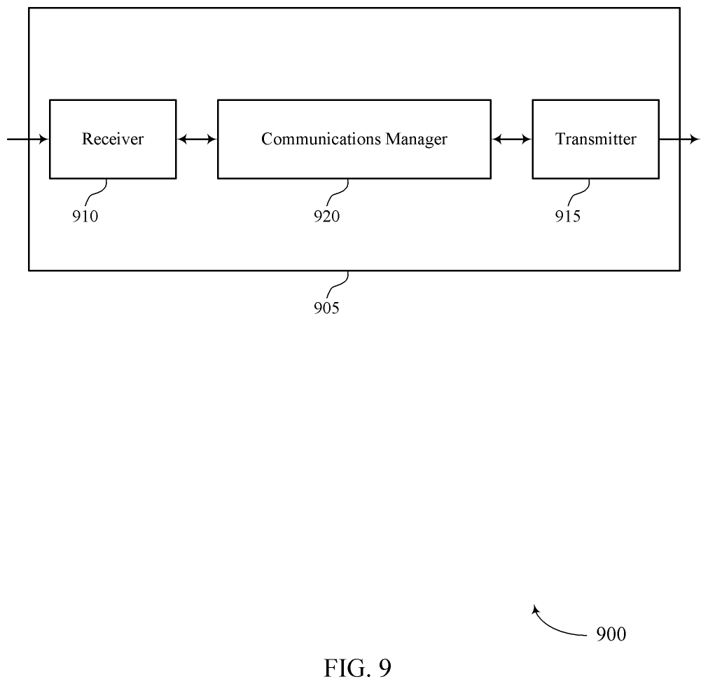

FIG. 9 illustrates a block diagram 900 of a device 905 that supports uplink transmission switching for unlicensed bands in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of uplink transmission switching for unlicensed bands as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 may be configured as or otherwise support a means for transmitting, to a UE, a control message that indicates a set of scheduling parameters for transmission of an uplink message via a licensed RF spectrum band. The communications manager 920 may be configured as or otherwise support a means for monitoring the licensed RF spectrum band and a shared RF spectrum band different from the licensed RF spectrum band for the uplink message. The communications manager 920 may be configured as or otherwise support a means for receiving, from the UE, the uplink message via one or more shared resources of the shared RF spectrum band in accordance with at least a portion of the set of scheduling parameters based on the monitoring.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for receiving uplink messages from a UE based on uplink transmit switching between licensed and unlicensed frequency bands. By enabling the device 905 to receive an uplink transmission on one or both of a licensed band and an unlicensed band, the techniques described herein may increase signaling throughput, improve spectral efficiency, and improve efficiency in resource utilization. Further, the device 905 may support concurrent uplink transmissions via one or both of the licensed and unlicensed bands, which may reduce latency and improve communication reliability.

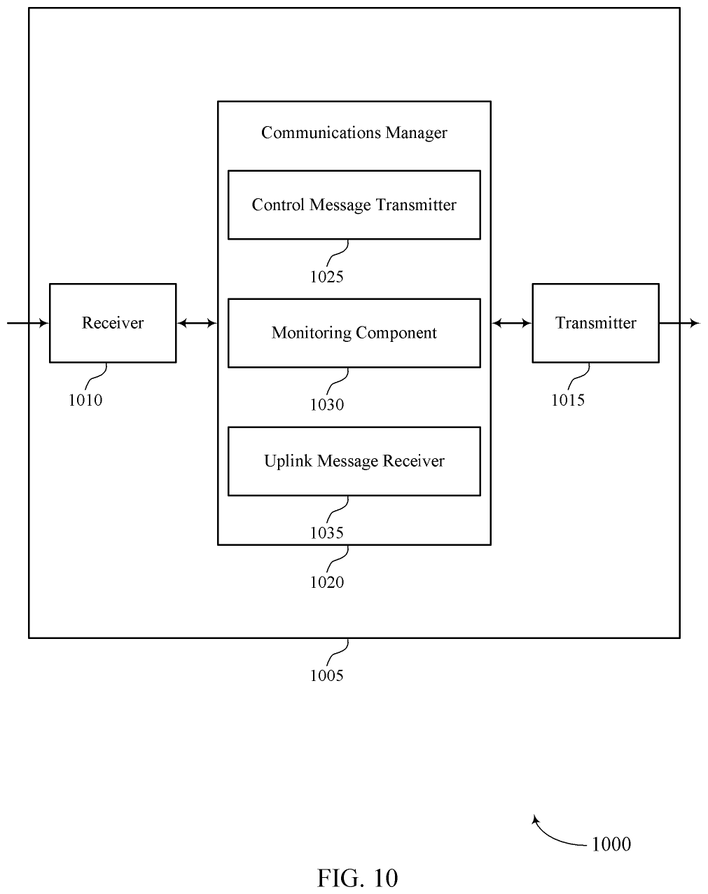

FIG. 10 illustrates a block diagram 1000 of a device 1005 that supports uplink transmission switching for unlicensed bands in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of uplink transmission switching for unlicensed bands as described herein. For example, the communications manager 1020 may include a control message transmitter 1025, a monitoring component 1030, an uplink message receiver 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The control message transmitter 1025 may be configured as or otherwise support a means for transmitting, to a UE, a control message that indicates a set of scheduling parameters for transmission of an uplink message via a licensed RF spectrum band. The monitoring component 1030 may be configured as or otherwise support a means for monitoring the licensed RF spectrum band and a shared RF spectrum band different from the licensed RF spectrum band for the uplink message. The uplink message receiver 1035 may be configured as or otherwise support a means for receiving, from the UE, the uplink message via one or more shared resources of the shared RF spectrum band in accordance with at least a portion of the set of scheduling parameters based on the monitoring.

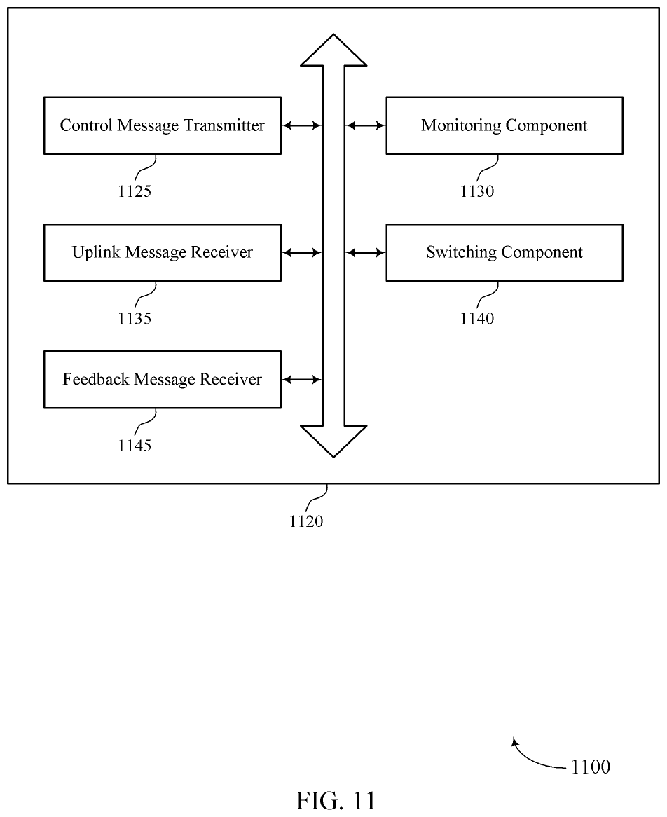

FIG. 11 illustrates a block diagram 1100 of a communications manager 1120 that supports uplink transmission switching for unlicensed bands in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of uplink transmission switching for unlicensed bands as described herein. For example, the communications manager 1120 may include a control message transmitter 1125, a monitoring component 1130, an uplink message receiver 1135, a switching component 1140, a feedback message receiver 1145, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The control message transmitter 1125 may be configured as or otherwise support a means for transmitting, to a UE, a control message that indicates a set of scheduling parameters for transmission of an uplink message via a licensed RF spectrum band. The monitoring component 1130 may be configured as or otherwise support a means for monitoring the licensed RF spectrum band and a shared RF spectrum band different from the licensed RF spectrum band for the uplink message. The uplink message receiver 1135 may be configured as or otherwise support a means for receiving, from the UE, the uplink message via one or more shared resources of the shared RF spectrum band in accordance with at least a portion of the set of scheduling parameters based on the monitoring.

In some examples, the switching component 1140 may be configured as or otherwise support a means for determining that an uplink transmit switching procedure of the UE was successful based on receiving the uplink message via the one or more shared resources of the shared RF spectrum band.

In some examples, a preparation time between transmitting the control message and receiving the uplink message is based on a switching period between bands for the UE, one or more capabilities of the UE, and a listening period for the UE. In some examples, the listening period includes a time duration or a symbol duration.

In some examples, the feedback message receiver 1145 may be configured as or otherwise support a means for receiving a feedback report associated with the uplink message based on the monitoring. In some examples, to support receiving the feedback report, the feedback message receiver 1145 may be configured as or otherwise support a means for receiving an acknowledgement associated with receiving the uplink message via the one or more shared resources of the shared RF spectrum band. In some examples, to support receiving the feedback report, the feedback message receiver 1145 may be configured as or otherwise support a means for receiving a negative acknowledgement associated with receiving the uplink licensed message via the licensed RF spectrum band.

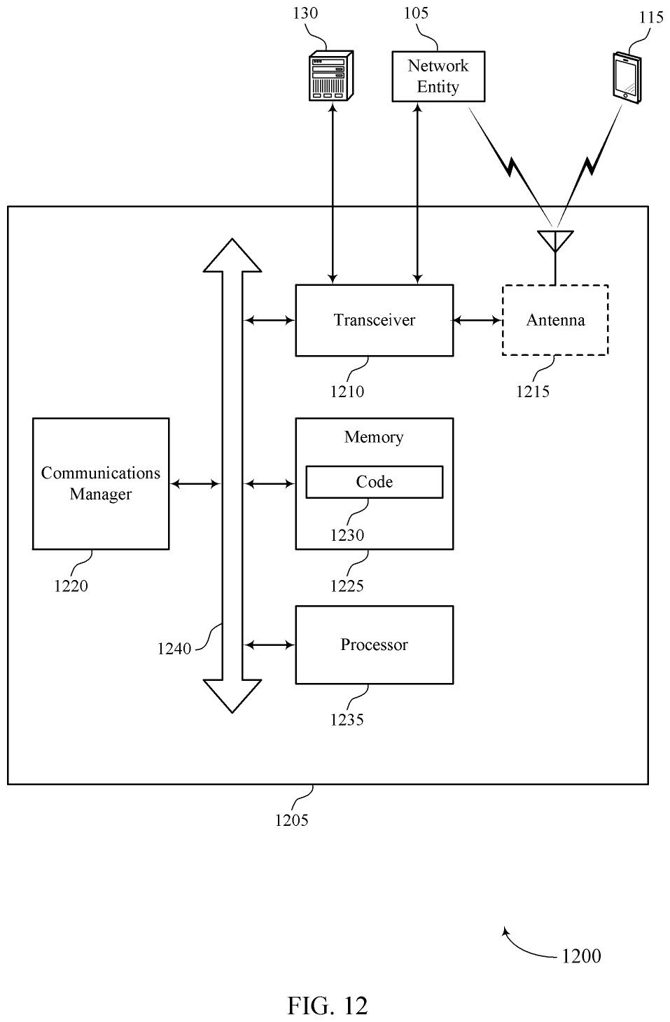

FIG. 12 illustrates a diagram of a system 1200 including a device 1205 that supports uplink transmission switching for unlicensed bands in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting uplink transmission switching for unlicensed bands). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 may be configured as or otherwise support a means for transmitting, to a UE, a control message that indicates a set of scheduling parameters for transmission of an uplink message via a licensed RF spectrum band. The communications manager 1220 may be configured as or otherwise support a means for monitoring the licensed RF spectrum band and a shared RF spectrum band different from the licensed RF spectrum band for the uplink message. The communications manager 1220 may be configured as or otherwise support a means for receiving, from the UE, the uplink message via one or more shared resources of the shared RF spectrum band in accordance with at least a portion of the set of scheduling parameters based on the monitoring.

By including or configuring the communications manager 1220 in accordance with examples as described herein, the device 1205 may support techniques for receiving uplink messages from a UE based on uplink transmit switching between licensed and unlicensed frequency bands. By enabling the device 1205 to receive an uplink transmission on one or both of a licensed band and an unlicensed band, the techniques described herein may increase signaling throughput, improve spectral efficiency, and improve efficiency in resource utilization. Further, the device 1205 may support concurrent uplink transmissions via one or both of the licensed and unlicensed bands, which may reduce latency and improve communication reliability. Enabling the device 1205 to utilize an unlicensed band for uplink communications may also reduce usage of limited bandwidth availability in licensed bands.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of uplink transmission switching for unlicensed bands as described herein, or the processor 1235 and the memory 1225 may be otherwise configured to perform or support such operations.

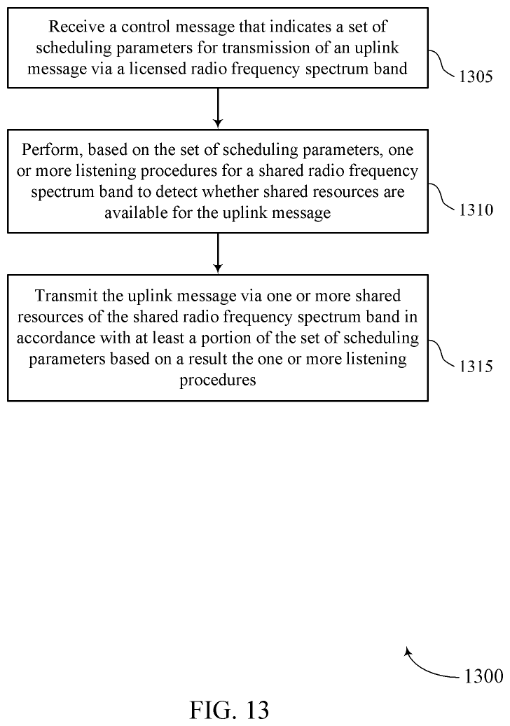

FIG. 13 illustrates a flowchart illustrating a method 1300 that supports uplink transmission switching for unlicensed bands in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a control message that indicates a set of scheduling parameters for transmission of an uplink message via a licensed RF spectrum band. The operations of 1305 may be performed in accordance with examples as disclosed herein. In some examples, aspects of the operations of 1305 may be performed by a control message receiver 725 as described with reference to FIG. 7.

At 1310, the method may include performing, based on the set of scheduling parameters, one or more listening procedures for a shared RF spectrum band to detect whether shared resources are available for the uplink message. The operations of 1310 may be performed in accordance with examples as disclosed herein. In some examples, aspects of the operations of 1310 may be performed by a listening component 730 as described with reference to FIG. 7.

At 1315, the method may include transmitting the uplink message via one or more shared resources of the shared RF spectrum band in accordance with at least a portion of the set of scheduling parameters based on a result of the one or more listening procedures. The operations of 1315 may be performed in accordance with examples as disclosed herein. In some examples, aspects of the operations of 1315 may be performed by an uplink message transmitter 735 as described with reference to FIG. 7.

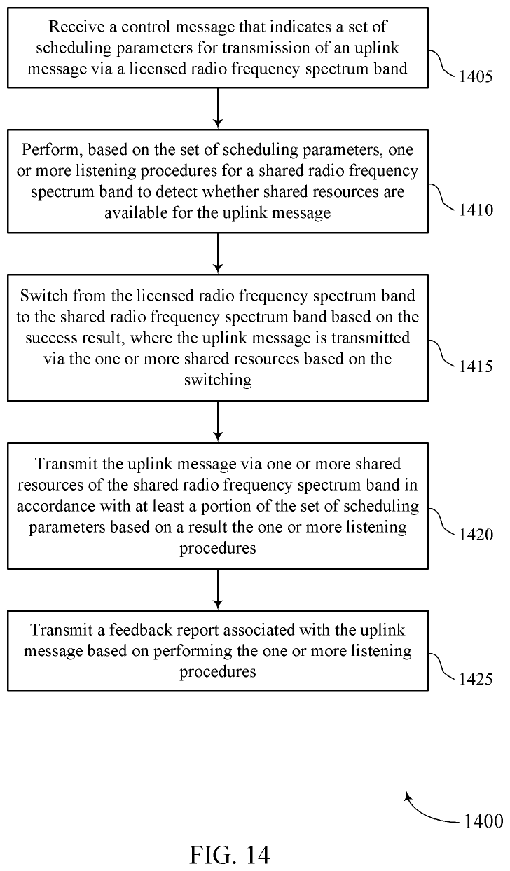

FIG. 14 illustrates a flowchart illustrating a method 1400 that supports uplink transmission switching for unlicensed bands in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a control message that indicates a set of scheduling parameters for transmission of an uplink message via a licensed RF spectrum band. The operations of 1405 may be performed in accordance with examples as disclosed herein. In some examples, aspects of the operations of 1405 may be performed by a control message receiver 725 as described with reference to FIG. 7.

At 1410, the method may include performing, based on the set of scheduling parameters, one or more listening procedures for a shared RF spectrum band to detect whether shared resources are available for the uplink message. The operations of 1410 may be performed in accordance with examples as disclosed herein. In some examples, aspects of the operations of 1410 may be performed by a listening component 730 as described with reference to FIG. 7.

At 1415, the method may include switching from the licensed RF spectrum band to the shared RF spectrum band based on the success result, where the uplink message is transmitted via the one or more shared resources based on the switching. The operations of 1415 may be performed in accordance with examples as disclosed herein. In some examples, aspects of the operations of 1415 may be performed by a switching component 740 as described with reference to FIG. 7.

At 1420, the method may include transmitting the uplink message via one or more shared resources of the shared RF spectrum band in accordance with at least a portion of the set of scheduling parameters based on a result of the one or more listening procedures. The operations of 1420 may be performed in accordance with examples as disclosed herein. In some examples, aspects of the operations of 1420 may be performed by an uplink message transmitter 735 as described with reference to FIG. 7.

At 1425, the method may include transmitting a feedback report associated with the uplink message based on performing the one or more listening procedures. The operations of 1425 may be performed in accordance with examples as disclosed herein. In some examples, aspects of the operations of 1425 may be performed by a feedback component 745 as described with reference to FIG. 7.

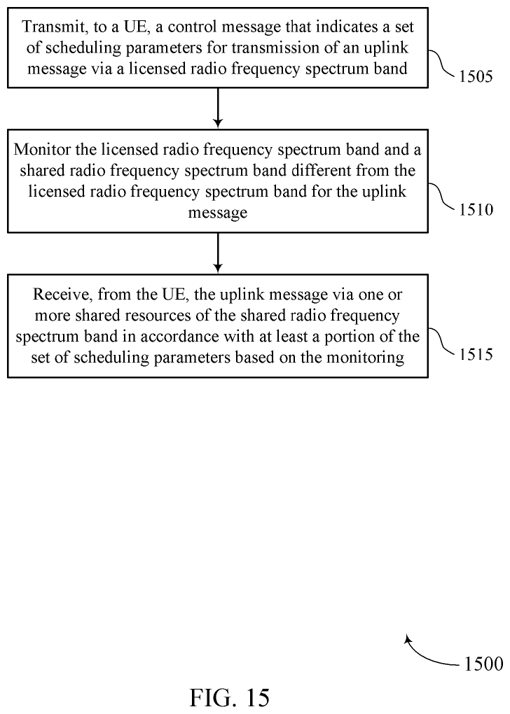

FIG. 15 illustrates a flowchart illustrating a method 1500 that supports uplink transmission switching for unlicensed bands in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting, to a UE, a control message that indicates a set of scheduling parameters for transmission of an uplink message via a licensed RF spectrum band. The operations of 1505 may be performed in accordance with examples as disclosed herein. In some examples, aspects of the operations of 1505 may be performed by a control message transmitter 1125 as described with reference to FIG. 11.

At 1510, the method may include monitoring the licensed RF spectrum band and a shared RF spectrum band different from the licensed RF spectrum band for the uplink message. The operations of 1510 may be performed in accordance with examples as disclosed herein. In some examples, aspects of the operations of 1510 may be performed by a monitoring component 1130 as described with reference to FIG. 11.

At 1515, the method may include receiving, from the UE, the uplink message via one or more shared resources of the shared RF spectrum band in accordance with at least a portion of the set of scheduling parameters based on the monitoring. The operations of 1515 may be performed in accordance with examples as disclosed herein. In some examples, aspects of the operations of 1515 may be performed by an uplink message receiver 1135 as described with reference to FIG. 11.

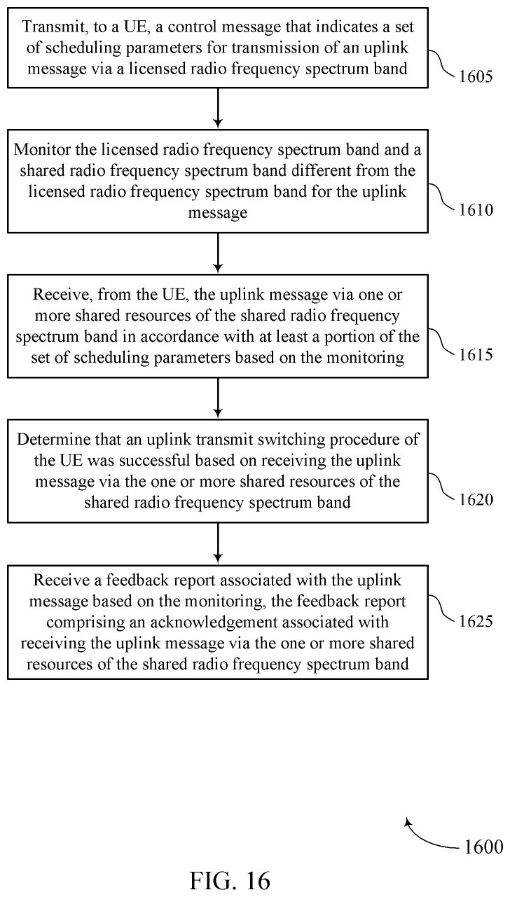

FIG. 16 illustrates a flowchart illustrating a method 1600 that supports uplink transmission switching for unlicensed bands in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE, a control message that indicates a set of scheduling parameters for transmission of an uplink message via a licensed RF spectrum band. The operations of 1605 may be performed in accordance with examples as disclosed herein. In some examples, aspects of the operations of 1605 may be performed by a control message transmitter 1125 as described with reference to FIG. 11.

At 1610, the method may include monitoring the licensed RF spectrum band and a shared RF spectrum band different from the licensed RF spectrum band for the uplink message. The operations of 1610 may be performed in accordance with examples as disclosed herein. In some examples, aspects of the operations of 1610 may be performed by a monitoring component 1130 as described with reference to FIG. 11.

At 1615, the method may include receiving, from the UE, the uplink message via one or more shared resources of the shared RF spectrum band in accordance with at least a portion of the set of scheduling parameters based on the monitoring. The operations of 1615 may be performed in accordance with examples as disclosed herein. In some examples, aspects of the operations of 1615 may be performed by an uplink message receiver 1135 as described with reference to FIG. 11.

At 1620, the method may include determining that an uplink transmit switching procedure of the UE was successful based on receiving the uplink message via the one or more shared resources of the shared RF spectrum band. The operations of 1620 may be performed in accordance with examples as disclosed herein. In some examples, aspects of the operations of 1620 may be performed by a switching component 1140 as described with reference to FIG. 11.

At 1625, the method may include receiving a feedback report associated with the uplink message based on the monitoring, where the feedback report comprises an acknowledgement associated with receiving the uplink message via the one or more shared resources of the shared RF spectrum band. The operations of 1625 may be performed in accordance with examples as disclosed herein. In some examples, aspects of the operations of 1625 may be performed by a feedback message receiver 1145 as described with reference to FIG. 11.

The following provides an overview of aspects of the present disclosure:

Aspect 1: A method for wireless communications at a UE, comprising: receiving a control message that indicates a set of scheduling parameters for transmission of an uplink message via a licensed RF spectrum band; performing, based at least in part on the set of scheduling parameters, one or more listening procedures for a shared RF spectrum band to detect whether shared resources are available for the uplink message; and transmitting the uplink message via one or more shared resources of the shared RF spectrum band in accordance with at least a portion of the set of scheduling parameters based at least in part on a result of the one or more listening procedures.

Aspect 2: The method of aspect 1, wherein the result comprises a success result indicating that the one or more shared resources are available for the uplink message, and wherein transmitting the uplink message comprises: switching from the licensed RF spectrum band to the shared RF spectrum band based at least in part on the success result, wherein the uplink message is transmitted via the one or more shared resources based at least in part on the switching.

Aspect 3: The method of aspect 2, further comprising: switching from the shared RF spectrum band to the licensed RF spectrum band after transmitting the uplink message.

Aspect 4: The method of any of aspects 2 through 3, wherein a preparation time between receiving the control message and transmitting the uplink message is based at least in part on a switching period between bands for the UE, one or more capabilities of the UE, and a listening period corresponding to the one or more listening procedures.

Aspect 5: The method of aspect 4, wherein the listening period comprises a time duration or a symbol duration.

Aspect 6: The method of any of aspects 4 through 5, wherein a start time of the switching period corresponds to the UE detecting that the one or more shared resources of the shared RF spectrum band are available for the uplink message.

Aspect 7: The method of any of aspects 1 through 6, further comprising: transmitting a feedback report associated with the uplink message based at least in part on performing the one or more listening procedures.

Aspect 8: The method of aspect 7, wherein transmitting the feedback report comprises: transmitting an acknowledgement associated with transmitting the uplink message via the one or more shared resources of the shared RF spectrum band based at least in part on the result comprising a success result.

Aspect 9: The method of aspect 7, wherein transmitting the feedback report comprises: transmitting a negative acknowledgement based at least in part on the result comprising a failure result.

Aspect 10: The method of any of aspects 1 through 9, wherein up to two transmissions are scheduled for the licensed RF spectrum band and the shared RF spectrum band.

Aspect 11: A method for wireless communications at a network entity, comprising: transmitting, to a UE, a control message that indicates a set of scheduling parameters for transmission of an uplink message via a licensed RF spectrum band; monitoring the licensed RF spectrum band and a shared RF spectrum band different from the licensed RF spectrum band for the uplink message; and receiving, from the UE, the uplink message via one or more shared resources of the shared RF spectrum band in accordance with at least a portion of the set of scheduling parameters based at least in part on the monitoring.

Aspect 12: The method of aspect 11, further comprising: determining that an uplink transmit switching procedure of the UE was successful based at least in part on receiving the uplink message via the one or more shared resources of the shared RF spectrum band.

Aspect 13: The method of any of aspects 11 through 12, wherein a preparation time between transmitting the control message and receiving the uplink message is based at least in part on a switching period between bands for the UE, one or more capabilities of the UE, and a listening period for the UE.

Aspect 14: The method of aspect 13, wherein the listening period comprises a time duration or a symbol duration.

Aspect 15: The method of any of aspects 11 through 14, further comprising: receiving a feedback report associated with the uplink message based at least in part on the monitoring.

Aspect 16: The method of aspect 15, wherein receiving the feedback report comprises: receiving an acknowledgement associated with receiving the uplink message via the one or more shared resources of the shared RF spectrum band.

Aspect 17: The method of any of aspect 15, wherein receiving the feedback report comprises: receiving a negative acknowledgement associated with receiving the uplink licensed message via the licensed RF spectrum band.

Aspect 18: An apparatus for wireless communications at a UE, comprising a processor; memory coupled with the processor; and instructions stored in the memory and executable by the processor to cause the apparatus to perform a method of any of aspects 1 through 10.

Aspect 19: An apparatus for wireless communications at a UE, comprising at least one means for performing a method of any of aspects 1 through 10.

Aspect 20: A non-transitory computer-readable medium storing code for wireless communications at a UE, the code comprising instructions executable by a processor to perform a method of any of aspects 1 through 10.

Aspect 21: An apparatus for wireless communications at a network entity, comprising a processor; memory coupled with the processor; and instructions stored in the memory and executable by the processor to cause the apparatus to perform a method of any of aspects 11 through 17.

Aspect 22: An apparatus for wireless communications at a network entity, comprising at least one means for performing a method of any of aspects 11 through 17.

Aspect 23: A non-transitory computer-readable medium storing code for wireless communications at a network entity, the code comprising instructions executable by a processor to perform a method of any of aspects 11 through 17.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communications at a user equipment (UE), comprising:
receiving a control message that indicates a set of scheduling parameters for transmission of an uplink message via a licensed radio frequency spectrum band;
performing, based at least in part on the set of scheduling parameters, one or more listening procedures for a shared radio frequency spectrum band to detect whether shared resources are available for the uplink message; and
transmitting the uplink message via one or more shared resources of the shared radio frequency spectrum band in accordance with at least a portion of the set of scheduling parameters based at least in part on a result the one or more listening procedures.

2. The method of claim 1, wherein the result comprises a success result indicating that the one or more shared resources are available for the uplink message, and wherein transmitting the uplink message comprises:
switching from the licensed radio frequency spectrum band to the shared radio frequency spectrum band based at least in part on the success result, wherein the uplink message is transmitted via the one or more shared resources based at least in part on the switching.

3. The method of claim 2, further comprising:
switching from the shared radio frequency spectrum band to the licensed radio frequency spectrum band after transmitting the uplink message.

4. The method of claim 2, wherein a preparation time between receiving the control message and transmitting the uplink message is based at least in part on a switching period between bands for the UE, one or more capabilities of the UE, and a listening period corresponding to the one or more listening procedures.

5. The method of claim 4, wherein the listening period comprises a time duration or a symbol duration.

6. The method of claim 4, wherein a start time of the switching period corresponds to the UE detecting that the one or more shared resources of the shared radio frequency spectrum band are available for the uplink message.

7. The method of claim 1, further comprising:
transmitting a feedback report associated with the uplink message based at least in part on performing the one or more listening procedures.

8. The method of claim 7, wherein transmitting the feedback report comprises:
transmitting an acknowledgement associated with transmitting the uplink message via the one or more shared resources of the shared radio frequency spectrum band based at least in part on the result comprising a success result.

9. The method of claim 7, wherein transmitting the feedback report comprises:
transmitting a negative acknowledgement based at least in part on the result comprising a failure result.

10. The method of claim 1, wherein up to two transmissions are scheduled for the licensed radio frequency spectrum band and the shared radio frequency spectrum band.

11. A method for wireless communications at a network entity, comprising:
transmitting, to a user equipment (UE), a control message that indicates a set of scheduling parameters for transmission of an uplink message via a licensed radio frequency spectrum band;
monitoring the licensed radio frequency spectrum band and a shared radio frequency spectrum band different from the licensed radio frequency spectrum band for the uplink message; and
receiving, from the UE, the uplink message via one or more shared resources of the shared radio frequency spectrum band in accordance with at least a portion of the set of scheduling parameters based at least in part on the monitoring.

12. The method of claim 11, further comprising:
determining that an uplink transmit switching procedure of the UE was successful based at least in part on receiving the uplink message via the one or more shared resources of the shared radio frequency spectrum band.

13. The method of claim 11, wherein a preparation time between transmitting the control message and receiving the uplink message is based at least in part on a switching period between bands for the UE, one or more capabilities of the UE, and a listening period for the UE.

14. (canceled)

15. The method of claim 11, further comprising:
receiving a feedback report associated with the uplink message based at least in part on the monitoring.

16-17. (canceled)

18. An apparatus for wireless communications at a user equipment (UE), comprising:
a processor;
memory coupled with the processor; and
instructions stored in the memory and executable by the processor to cause the apparatus to:
receive a control message that indicates a set of scheduling parameters for transmission of an uplink message via a licensed radio frequency spectrum band;
perform, based at least in part on the set of scheduling parameters, one or more listening procedures for a shared radio frequency spectrum band to detect whether shared resources are available for the uplink message; and
transmit the uplink message via one or more shared resources of the shared radio frequency spectrum band in accordance with at least a portion of the set of scheduling parameters based at least in part on a result the one or more listening procedures.

19. The apparatus of claim 18, wherein the result comprises a success result indicating that the one or more shared resources are available for the uplink message, and wherein the instructions to transmit the uplink message are executable by the processor to cause the apparatus to:
switch from the licensed radio frequency spectrum band to the shared radio frequency spectrum band based at least in part on the success result, wherein the uplink message is transmitted via the one or more shared resources based at least in part on the switching.

20. The apparatus of claim 19, wherein the instructions are further executable by the processor to cause the apparatus to:
switch from the shared radio frequency spectrum band to the licensed radio frequency spectrum band after transmitting the uplink message.

21. The apparatus of claim 19, wherein a preparation time between receiving the control message and transmitting the uplink message is based at least in part on a switching period between bands for the UE, one or more capabilities of the UE, and a listening period corresponding to the one or more listening procedures.

22-23. (canceled)

24. The apparatus of claim 18, wherein the instructions are further executable by the processor to cause the apparatus to:
transmit a feedback report associated with the uplink message based at least in part on performing the one or more listening procedures.

25. (canceled)

27. The apparatus of claim 18, wherein up to two transmissions are scheduled for the licensed radio frequency spectrum band and the shared radio frequency spectrum band.

28-30. (canceled)
